(19) United States
(12) Patent Application Publication
(10) Pub. No.: US 2016/0320624 A1
(43) Pub. Date: Nov. 3, 2016

(54) HEAD-UP DISPLAY DEVICE

(71) Applicant: DENSO CORPORATION, Kariya-city (JP)

(72) Inventor: Ryo YAMAOKA, Kariya-city (JP)

(21) Appl. No.: 15/108,807

(22) PCT Filed: Mar. 26, 2015
(86) PCT No.: PCT/JP2015/001759

§ 371 Date: Jun. 29, 2016

(30) Foreign Application Priority Data
May 26, 2014 (JP) 2014-108315

(51) Int. Cl. G02B 27/01; B60K 35/00

(52) U.S. Cl. CPC G02B 27/0179; G02B 27/0101; G02B 27/0149; B60K 35/00; G02B 2027/0187; G02B 2027/0159; G02B 2027/0163; G02B 2027/0138; G02B 2027/0145; G02B 2027/0181

(57) ABSTRACT

A head-up display device is mounted on a mobile object having an imaging unit which images an eye of an occupant, and projects an image on a projection member of the mobile object to display a virtual image visible by the occupant in a viewing area. The head-up display device includes an optical member, and the viewing area is moved according to an orientation of the optical member which is changeable. The head-up display device includes an adjustment unit that automatically adjusts the orientation of the optical member based on a relative position of the eye imaged by the imaging unit relative to the viewing area.

### CROSS REFERENCE TO RELATED APPLICATION

This application is based on Japanese Patent Application No. 2014-108315 filed on May 26, 2014, the disclosure of which is incorporated herein by reference.

### TECHNICAL FIELD

The present disclosure relates to a head-up display device (hereafter, HUD device).

### BACKGROUND ART

Up to now, an HUD device that is mounted on a mobile object has been known, which projects an image on a projection member of the mobile object to display a virtual image visible by an occupant. In Patent Literature 1, an adjustment display, a mirror, and an object to be imaged are used in addition to the HUD device. As adjusting operation, an operator stops a vehicle at a predetermined position, and fixes the mirror and the object to be imaged at predetermined position. Further, the operator adjusts the HUD device while watching a display showing an image of the object captured by a vehicle exterior detection camera and an image of the mirror captured by a driver detection camera.

### PRIOR ART LITERATURES

### Patent Literature

Patent Literature 1: JP 2009-262666 A

### SUMMARY OF INVENTION

In Patent Literature 1, the complicated adjustment described above is required, and it is troublesome and difficult that a display position is adjusted to match a position of occupant's eye.

An object of the present disclosure is to provide an HUD device that is automatically adjustable so that a virtual image is displayed at a display position matching a position of occupant's eye.

According to an aspect of the present disclosure, a head-up display device that is mounted on a mobile object having an imaging unit which images an eye of an occupant, and that projects an image on a projection member of the mobile object to display a virtual image visible by the occupant in a viewing area includes an optical member. An orientation of the optical member is changeable. The viewing area is moved according to the orientation of the optical member. The head-up display device includes an adjustment unit that automatically adjusts the orientation of the optical member based on a relative position of the eye imaged by the imaging unit relative to the viewing area.

According to the above configuration, the viewing area is moved by changing the orientation of the optical member to enable the virtual image to be displayed according to the position of the occupant's eye. The orientation of the optical member is automatically adjusted on the basis of the relative position of the imaged occupant's eye to the viewing area. According to the above configuration, the HUD device can be provided, which enables automatic adjustment so that the virtual image is displayed at the display position matching the position of the occupant's eye without performing complicated adjusting operation by actually imaging the position of the occupant's eye to automatically adjust the orientation of the optical member.

### BRIEF DESCRIPTION OF DRAWINGS

FIG. 1 is a schematic view illustrating an HUD device according to a first embodiment mounted in a vehicle.

FIG. 2 is a schematic view illustrating an optical system of the HUD device according to the first embodiment.

FIG. 3 is an exploded perspective view illustrating a configuration of the HUD device according to the first embodiment.

FIG. 4 is a schematic view illustrating a change in an orientation of a concave mirror illustrated in FIG. 1.

FIG. 5 is a schematic view illustrating a relationship between a viewing area and a movable area according to the first embodiment.

FIG. 6 is a block diagram illustrating a control circuit according to the first embodiment.

FIG. 7 is a flowchart illustrating operation of the control circuit according to the first embodiment.

FIG. 8 is a schematic view illustrating an optical system of an HUD device according to a second embodiment.

FIG. 9 is a schematic view illustrating a relationship between a viewing area and a movable area according to the second embodiment, which corresponds to FIG. 5.

FIG. 10 is a flowchart illustrating operation of the control circuit according to the second embodiment.

FIG. 11 is a schematic view illustrating a manual adjustment switch according to a third embodiment.

FIG. 12 is a flowchart illustrating operation of a control circuit according to the third embodiment.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

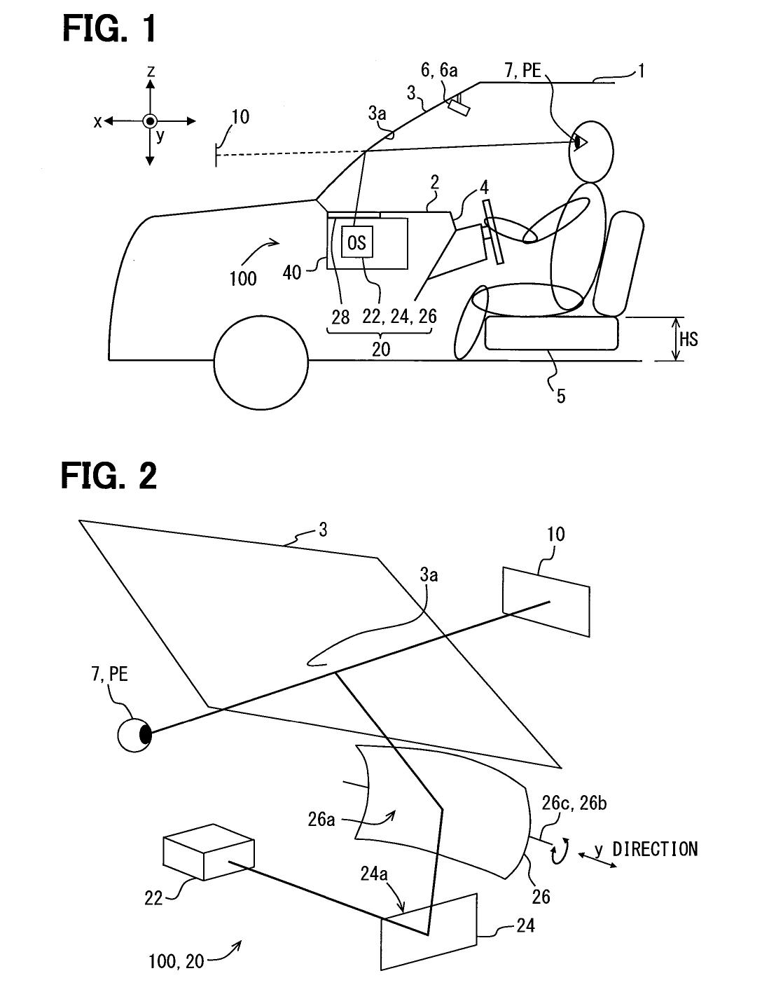

As illustrated in FIG. 1, an HUD device 100 according to a first embodiment is mounted in a vehicle 1 that is one type of a mobile object, and is housed in an instrument panel 2. The HUD device 100 projects an image on a windshield 3 as a projection member of the vehicle 1. As a result, the image projected by the HUD device 100 is visually recognized as a virtual image 10 by occupant's eye 7 in a viewing area 12 in an interior of the vehicle 1. In other words, a light of the image reflected on the windshield 3 reaches the position of the occupant's eye 7, and the occupant perceives the light. As a result, the occupant can recognize a vehicle state value such as a vehicle speed or a remaining fuel level, or vehicle information such as road information or visibility auxiliary information.

The windshield 3 of the vehicle 1 has a projection surface 3a on which the image is projected as an interior side surface formed into a curved concave shape or a flat planar shape. The windshield 3 may have an angular difference for superimposing virtual images reflected on the respective surfaces of the interior side surface and the exterior side surface on each other. The windshield 3 may be provided with a vapor deposited film or a film for suppressing a luminance of the virtual image by reflection on the exterior side surface. As the projection member, a combiner that is separated from the vehicle 1 may be installed in the vehicle 1 in place of the windshield 3, and the image may be projected on the combiner.

In the present embodiment, a vertical direction of the vehicle 1 located on a horizontal plane is defined as a z-direction. A longitudinal direction of the vehicle 1 in which the virtual image 10 is projected frontward is defined as an x-direction. A lateral direction of the vehicle 1 in which the virtual image 10 is projected frontward is defined as a y-direction.

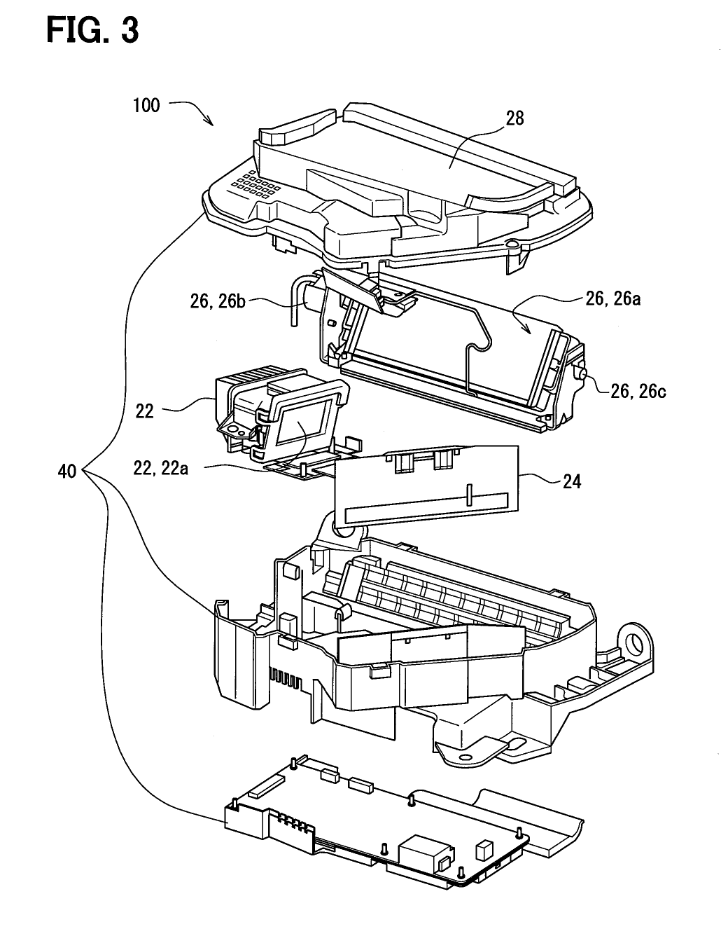

First, a specific configuration of the HUD device 100 will be described in brief. The HUD device 100 includes an optical system 20 and a control circuit 30 that controls the optical system 20. As illustrated in FIGS. 2 and 3, the optical system 20 includes a projector 22, a plane mirror 24, a concave mirror 26, and a dust-proof sheet 28.

The projector 22 is a liquid crystal projector transmitting a light from an internal light source (not shown) through a liquid crystal panel 22a on a surface of the projector 22 to form an image, and projects a light of the image toward the plane mirror 24 as an optical beam. In the present embodiment, a light emitting device formed of a light emitting diode is employed as the light source, and a dot matrix color TFT liquid crystal panel is employed as the liquid crystal panel 22a. The projector 22 may have any other configurations that can project the image, and may be configured by, for example, an MEMS scanner projector using a laser, or an organic EL projector.

The plane mirror 24 is formed by depositing aluminum as a reflecting surface 24a on a surface of a base material made of synthetic resin or glass. The reflecting surface 24a is formed into a smooth flat shape. With that shape, the plane mirror 24 reflects the light of the image from the projector 22 toward the concave mirror 26.

The concave mirror 26 is formed by depositing aluminum as a reflecting surface 26a on a surface of a base material made of synthetic resin or glass. The reflecting surface 26a is formed into a smooth curved shape with a concave surface in which a center of the concave mirror 26 is recessed. In more detail, in order to suppress a distortion caused in a virtual image of the image projected on a projection surface 3a of the windshield 3, the reflecting surface 26a is formed into an aspherical shape corresponding to a shape of the projection surface 3a, more precisely a freely curved shape. Such an aspherical shape is set by considering a vertical movement of the virtual image 10 corresponding to the orientation of the concave mirror 26 by the rotational driving around a first axis 26c which will be described later. With such a shape, the concave mirror 26 reflects the light of the image from the plane mirror 24 toward the windshield 3 of the vehicle 1 located above the HUD device 100 through the dust-proof sheet 28.

The concave mirror 26 includes the first axis 26c that is disposed to pass through a center of the concave mirror 26, and extends in the y-direction. The concave mirror 26 is rotationally driven around the first axis 26c by a stepping motor 26b according to a drive signal from the control circuit 30 which will be described later. In other words, the concave mirror 26 corresponds to an optical member whose orientation is changeable. The stepping motor 26b corresponds to a driving unit for driving the concave mirror 26.

The dust-proof sheet 28 is formed into a plate shape having translucency which is made of a synthetic resin such as polycarbonate resin. The dust-proof sheet 28 closes an opening of a housing 40 that houses the optical system 20 to transmit the light of the image from the concave mirror 26 toward the windshield 3 of the vehicle 1, and prevents dust or the like outside of the HUD device 100 from entering an interior of the device 100.

The light of the image projected on the windshield 3 reaches the viewing area 12 on the rear side of the windshield 3 as the light beam. When a position PE of the occupant's eye 7 falls within the viewing area 12, the light of the image can be visually recognized as the virtual image 10 on the front side. When the position PE of the occupant's eye 7 falls outside of the viewing area 12, the light of the image cannot be sufficiently visually recognized as the virtual image 10.

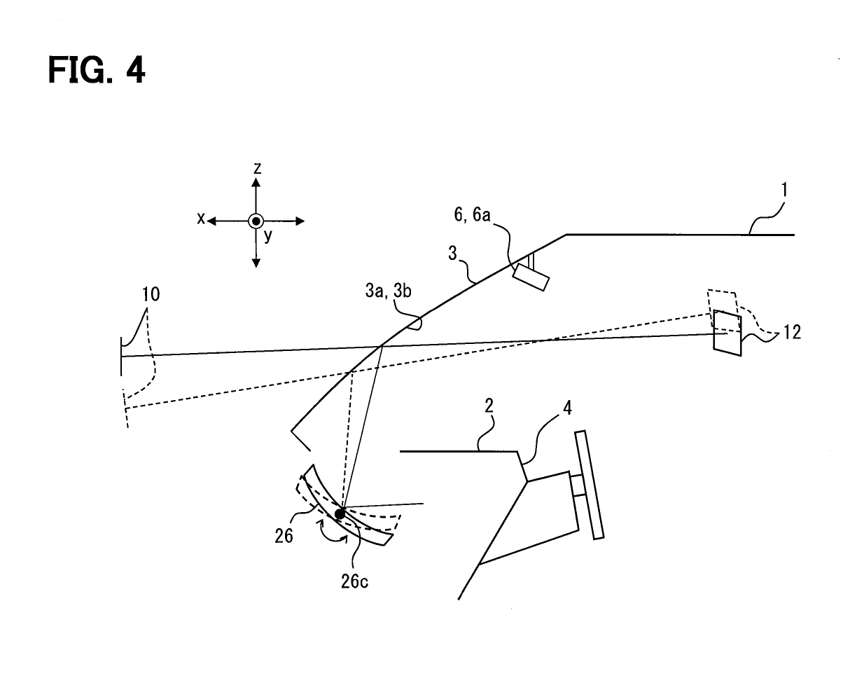

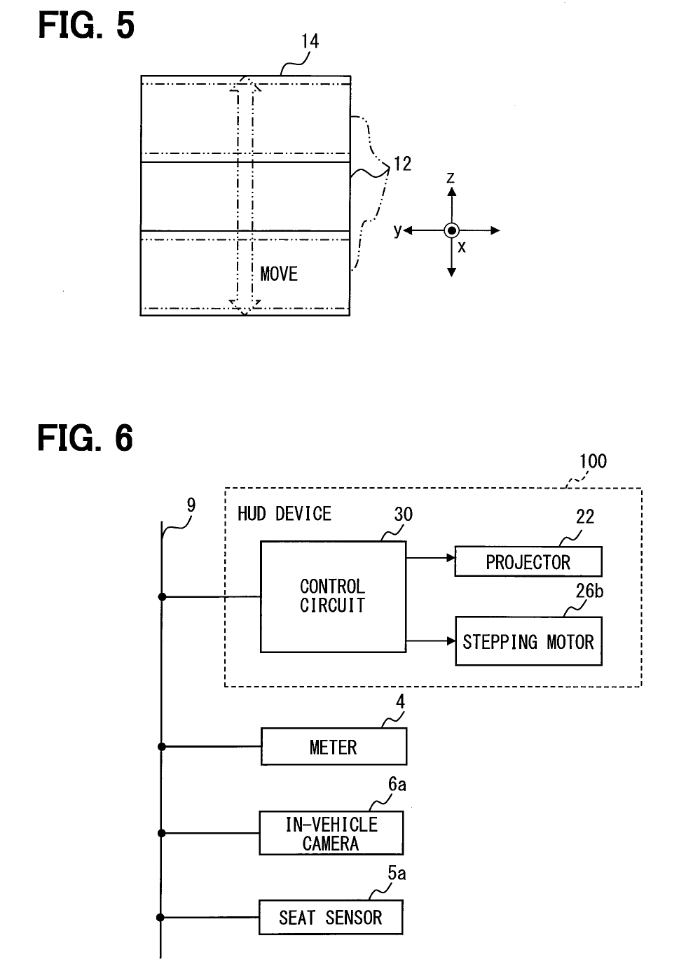

The change in the orientation of the concave mirror 26 in the optical system 20 will be described with reference to FIGS. 4 and 5 below. When the concave mirror 26 is rotationally driven around the axis 26c, the orientation of the concave mirror 26, that is, an angle of the reflecting surface 26a is changed, to thereby change a reflection angle of the light of the image. A projection position and an incident angle of the light of the image, whose reflection angle has been changed, are also changed on the windshield 3, and an access range where the light of the image can reach as the light beam is also changed in response to those changes. In short, when the orientation of the concave mirror 26 is changed, the viewing area 12 is moved according to the orientation of the concave mirror 26.

In the present embodiment, as illustrated in FIG. 4, when the orientation of the concave mirror 26 is rotationally driven in one way around the first axis 26c, the viewing area 12 moves upward in the z-direction relative to the vehicle 1. In that case, a display position of the virtual image 10 displayed on the front side of the vehicle 1 is moved downward in the z-direction relative to the vehicle 1. When the orientation of the concave mirror 26 is rotationally driven in another way around the first axis 26c, the viewing area 12 is moved downward in the z-direction relative to the vehicle 1. In that case, the display position of the virtual image 10 is moved upward in the z-direction relative to the vehicle 1.

As described above, the optical system 20 moves the viewing area 12 in the z-direction by changing the orientation of the concave mirror 26 by the rotational driving around the first axis 26c.

In the present embodiment, the viewing area 12 is able to be moved by the optical system 20 in the z-direction according to the orientation of the concave mirror 26 within a movable area 14. The viewing area 12 is moved vertically in the z-direction by the rotational driving around the first axis 26c along the y-direction in the HUD device 100. A relationship between the viewing area 12 and the movable area 14 is apparent in FIG. 5. The y-direction is perpendicular to the z-direction and the longitudinal direction of the vehicle 1.

The control circuit 30 is, for example, an electronic circuit mainly including a microcomputer (not shown). As illustrated in FIG. 6, the control circuit 30 is electrically connected to the projector 22 and the stepping motor 26b of the concave mirror 26. The control circuit 30 can communicate through a vehicle LAN 9 with an in-vehicle camera 6a, a meter 4, and a seat sensor 5a for detecting a position of a seat 5 on which the occupant is seated. The control circuit 30 can control a display state of the projector 22 and the orientation of the concave mirror 26 on the basis of signals input from the in-vehicle camera 6a, the meter 4, and the seat sensor 5a, and can output a signal to the meter 4.

Although not shown in detail, the meter 4 is a vehicle display device that indicates a scale as an indicator by a pointer to display a vehicle state value, and displays vehicle information and alert by image display on a liquid crystal display or the like.

The in-vehicle camera 6a is, for example, a CCD camera compatible with the detection of an infrared light, and disposed above the windshield 3 as illustrated in FIGS. 1 and 4. An infrared light source not shown is disposed at a position close to an optical axis of the in-vehicle camera 6a. The in-vehicle camera 6a is used, for example, in a monitoring system 6 that images a facial expression of a driver who is the occupant, and generates an alert sound for the driver predicted to feel sleepy, and therefore can image eye 7 of the driver who is the occupant.

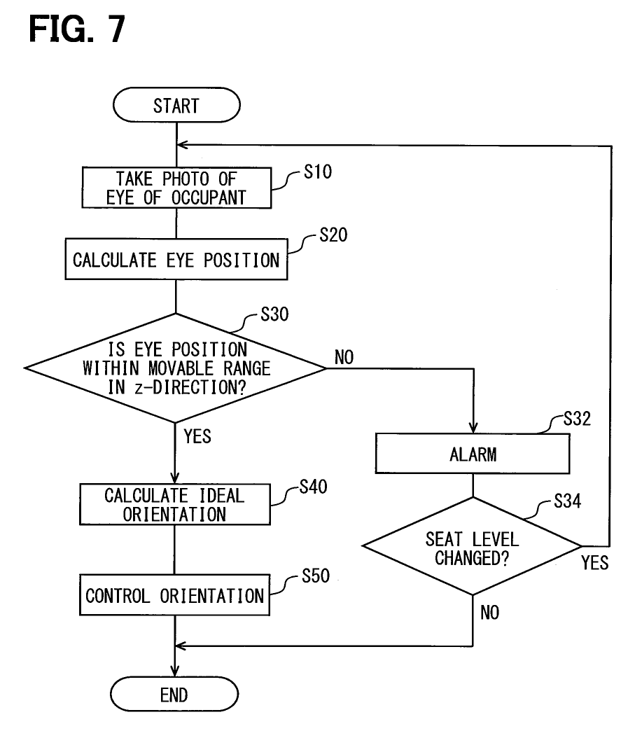

Next, a flowchart will be described in detail with reference to FIG. 7, which is implemented by execution of a computer program by the control circuit 30 in the first embodiment in cooperation with the monitoring system 6 when an engine switch of the vehicle 1 is turned on.

In Step S10, the occupant's eye 7 is imaged. Specifically, the in-vehicle camera 6a images the facial expression including the occupant's eye 7, and the captured image data is input to the control circuit 30. After processing in Step S10, the process proceeds to Step S20.

In Step S20, the position PE of the occupant's eye 7 is calculated. For example, a cornea reflection image of the occupant's eye 7 by the infrared light source is extracted from captured image data obtained in Step S10. The position PE of the eye 7 is calculated according to the position of the cornea reflection image in the captured image data by considering the placement of the in-vehicle camera 6a and the infrared light source. The position of the eye 7 may be calculated through another method. After processing in Step S20, the process proceeds to Step S30.

In Step S30, it is determined whether the position PE of the eye 7 falls within the movable area 14 in the z-direction, or not. Specifically, a memory (not shown) of the control circuit 30 stores an extent of the movable area 14 in the z-direction in advance, and it is determined whether the position PE of the eye 7 calculated in Step S20 falls within the area in the z-direction, or not. In the present embodiment, the determination is executed for each of a right eye 7 and a left eye 7, and a negative determination is made unless both of the eye 7 fall within the area. Meanwhile, when one eye 7 falls within the area, a positive determination may be made. When the positive determination is made in Step S30, the process proceeds to Step S40. When the negative determination is made in Step S30, the flow proceeds to Step S32.

In Step S40, an ideal orientation of the concave mirror 26 is calculated. Specifically, the ideal orientation of the concave mirror 26 is calculated to be associated with the position PE of the eye 7 calculated in Step S20. A rotational driving amount of the first axis 26c to put the concave mirror 26 into the ideal orientation is calculated on the basis of a relative position of the eye 7 calculated in Step S20 to the present viewing area 12.

In the present embodiment, the ideal orientation represents an orientation of the concave mirror 26 by which the position PE of the eye 7 calculated in Step S20 is positioned at the center of the viewing area 12 in the z-direction. However, when the position PE of the eye 7 is close to a boundary of the movable area 14 in the z-direction, because the viewing area 12 cannot be moved to be centered, the ideal orientation is set by rotationally driving the first axis 26c to the limit for coming closer to the center. After processing Step S40, the process proceeds to Step S50.

In Step S50, the orientation of the concave mirror 26 is adjusted. The stepping motor 26b that has received the drive signal rotationally drives the concave mirror 26 around the first axis 26c to change the orientation of the concave mirror 26 on the basis of the rotational driving amount of the first axis 26c calculated in Step S40. With Step S50, a series of processing is completed.

When it is determined that the position PE of the occupant's eye 7 deviates from the movable area 14 in the z-direction in Step S30, the occupant is alerted in Step S32. Specifically, when the control circuit 30 outputs an alert signal to the meter 4, an alert message is displayed on the liquid crystal display of the meter 4. In the present embodiment, the alert is made to encourage a height HS of the seat 5 on which the occupant is seated to change. After a predetermined time from the processing in Step S32, the flow proceeds to Step S34.

In Step S34, it is determined whether the height HS of the seat 5 has been changed, or not. Specifically, the seat sensor 5a detects that the height HS of the seat 5 has been changed by the occupant, and it is determined whether a detection signal of the seat sensor 5a has been input to the control circuit 30, or not. When the positive determination is made in Step S34, the imaging in Step S10 starts again. In other words, the operation for automatically adjusting the orientation starts.

As described above, the control circuit 30 automatically adjusts the orientation of the concave mirror 26 so as to match the ideal orientation associated with the relative position of the occupant's eye 7 imaged by the in-vehicle camera 6a to the viewing area 12. The automatic adjustment means that the control circuit 30 changes the orientation of the concave mirror 26 on the basis of the signal input from the in-vehicle camera 6a or the like.

In the first embodiment, the in-vehicle camera 6a configures “imaging unit”, and the control circuit 30 that executes Step S50 configures “adjustment unit”. The control circuit 30 that executes Step S30 configures “determination unit”, and the control circuit 30 that executes Step S32 configures “alert unit”.

### (Effects)

The effects of the first embodiment described above will be described below.

According to the first embodiment, the optical system 20 moves the viewing area 12 for the image according to the orientation of the concave mirror 26. According to the above configuration, the viewing area 12 is moved by changing the orientation of the concave mirror 26 to enable the virtual image 10 to be displayed according to the position PE of the occupant's eye 7. The orientation of the concave mirror 26 is automatically adjusted to match the orientation associated with the relative position on the basis of the relative position of the imaged occupant's eye 7 to the viewing area 12. According to the above configuration, the HUD device 100 can be provided, which actually images the position PE of the occupant's eye 7 and automatically adjusts the orientation of the concave mirror 26 to the display position matching the position PE of the occupant's eye 7 without imposing complicated adjusting operation.

According to the first embodiment, when it is determined that the position PE of the occupant's eye 7 falls within the movable area in the z-direction, the control circuit 30 automatically adjusts the orientation of the concave mirror by the rotational driving around the first axis 26c. According to the above configuration, even when the position PE of the occupant's eye 7 falls outside of the viewing area 12 in the z-direction, the orientation of the concave mirror 26 can be automatically adjusted to the display position matching the position PE of the occupant's eye 7.

According to the first embodiment, when it is determined that the position PE of the occupant's eye 7 deviates from the movable area 14 in the z-direction, the control circuit 30 alerts the occupant to change the height HS of the seat 5 on which the occupant is seated. According to the above configuration, the occupant is encouraged to change the height HS of the seat 5 so that the position PE of the occupant's eye 7 falls within the movable area 14 in the z-direction. As a result, the occupant can recognize that the HUD device 100 is not out of order while the virtual image 10 is invisible.

According to the first embodiment, when the occupant changes the height HS of the seat 5, the control circuit 30 starts to automatically adjust the orientation of the concave mirror 26. According to the above configuration, the automatic adjustment can be performed in a state where the position PE of the occupant's eye 7 falls within the movable area at a timing when the occupant changes the height HS of the seat 5.

### Second Embodiment

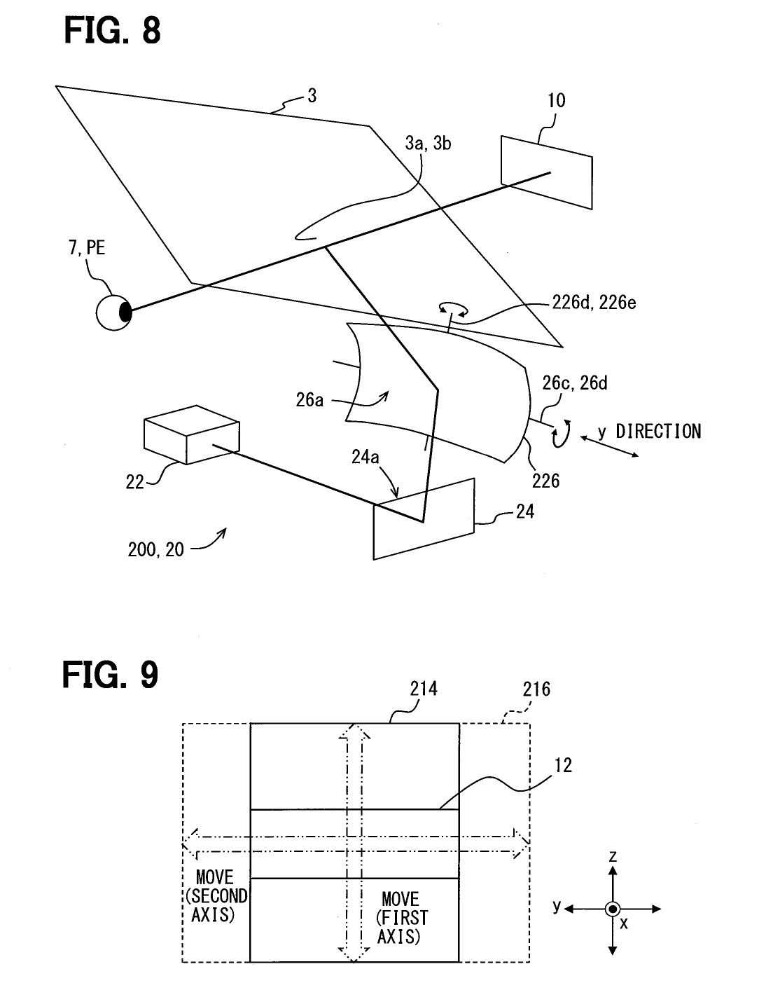

As illustrated in FIGS. 8 to 10, a second embodiment is a modification of the first embodiment. In the second embodiment, configurations different from those in the first embodiment will be mainly described.

A concave mirror 226 of an HUD device 200 according to the second embodiment is identical in the configuration of a reflecting surface 26a with that of the first embodiment. However, as illustrated in FIG. 8, the concave mirror 226 further has a second axis 226d that is disposed to pass through a center of the concave mirror 226, intersects with the first axis 26c at the center of the concave mirror 226, and is perpendicular to a first axis 26c. The concave mirror 226 is rotationally driven around the first axis by the stepping motor 26b according to a drive signal from a control circuit 30 which will be described later. In addition, the concave mirror 226 is rotationally driven around the second axis 226d by another stepping motor 226e. In other words, the concave mirror 226 configures an optical member whose orientation is changeable.

A change in the orientation of the concave mirror 226 by the rotational driving around the first axis 26c is identical with that of the first embodiment. The viewing area 12 is moved according to the orientation of the concave mirror 226 when the orientation of the concave mirror 226 is changed by the rotational driving around the second axis 226d.

Specifically, when the orientation of the concave mirror 226 is rotationally driven around the second axis 226d, the viewing area 12 moves in a y-direction, i.e., in a lateral direction of the vehicle 1. In other words, the optical system 20 changes the orientation of the concave mirror 226 by the rotational driving around the second axis 226d, to thereby move the viewing area 12 in the y-direction. In that case, the display position of the virtual image 10 is moved in the y-direction, i.e., in the lateral direction of the vehicle 1.

However, when a virtual image 10 displayed with a width in the lateral direction which is the y-direction moves in the lateral direction, an enlargement rate of the virtual image 10 is asymmetric on the right and left sides with respect to a center of the virtual image. Therefore, a difference occurs in the distortion between the right and left sides, and the distortion is likely to be noticeable. The second axis 226d is used as an auxiliary axis when the occupant cannot sufficiently visually recognize a light of the image as the virtual image 10 by only the rotational driving around the first axis 26c. In the movement of the viewing area 12 relative to the rotational driving around the second axis 226d, an initial orientation of the concave mirror 226 is defined such that the difference in the enlargement rate of the virtual image 10 between the right and left sides with respect to the center of the virtual image 10 becomes the minimum.

A movable area 214 in the second embodiment is defined as an extent in which the viewing area 12 is moved in the z-direction depending on the orientation of the concave mirror 26 by the optical system 20 as in the first embodiment. However, as illustrated in FIG. 9, in the HUD device 200 in which the viewing area 12 also moves laterally in the y-direction by the rotational driving around the second axis 226d perpendicular to the first axis 26c, an extent in which the viewing area 12 moves in the z-direction relative to the initial orientation is set as the movable area 214. The viewing area 12 deviates from the movable area in the y-direction with the rotational driving around the second axis 226d, and an extent in which the viewing area 12 moves from the movable area 214 in the y-direction is defined as an extension area 216. In the present embodiment, at the initial orientation, the first axis 26c is put into a state to extend along the y-direction, and the viewing area 12 is located in the middle of the extension area 216 in the y-direction. Meanwhile, in FIG. 9, the viewing area 12 corresponding to the initial orientation is indicated by solid lines. In FIG. 9, the movable area 214 including the viewing area 12 corresponding to the initial orientation is also indicated by solid lines, and the extension area 216 is indicated by dashed lines.

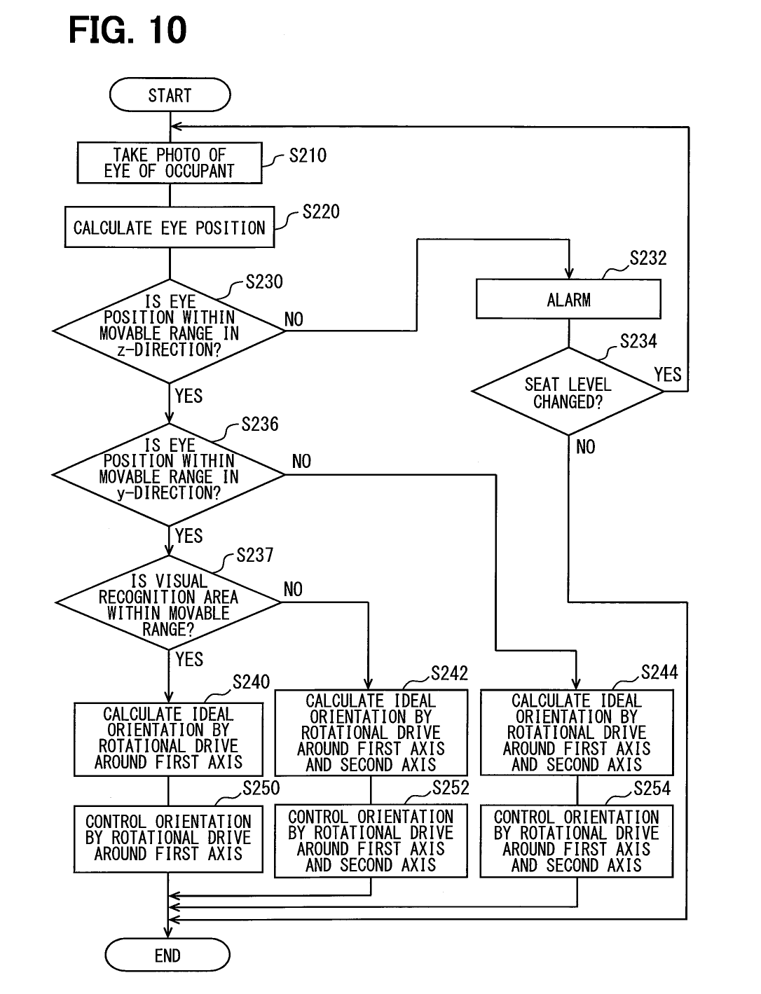

Next, a flowchart will be described in detail with reference to FIG. 10, which is implemented by execution of the computer program by the control circuit 30 in the first embodiment in cooperation with the monitoring system 6 when a parking state of the vehicle 1 is canceled. Meanwhile, the cancel of the parking state of the vehicle 1 means that both of a parking brake and a parking range in a shift lever are canceled.

In Steps S210 to S220, the same processing as that in Steps S10 to S20 in the first embodiment is conducted. After processing in Step S220, the process proceeds to Step S230.

Step S230 performs the same determination as that in Step S30 of the first embodiment. When the positive determination is made in Step S230, the process proceeds to Step S236. When the negative determination is made in Step S230, the process proceeds to Step S232. In Steps S232 and S234, the same processing as that in Steps S32 and S34 of the first embodiment is performed.

When it is determined that the position PE of the occupant's eye 7 falls within the movable area 214 in the z-direction in Step S230, it is determined whether the position PE of the eye 7 falls within the movable area 214 in the y-direction, or not in Step S236. Specifically, a memory (not shown) of the control circuit 30 stores an extent of the movable area 214 in the y-direction in advance, and it is determined whether the position PE of the eye 7 calculated in Step S220 falls within the area in the y-direction, or not. In the present embodiment, when both of the eyes 7 do not fall within the area, the negative determination is made. Alternatively, when one eye 7 falls within the area, the positive determination may be made. When the positive determination is made in Step S236, the process proceeds to Step S237. When the negative determination is made in Step S236, the process proceeds to Step S244.

In Step S237, it is determined whether the viewing area 12 falls within the movable area 214, or not. Specifically, when the orientation of the concave mirror 226 is the initial orientation, because the viewing area 12 falls within the movable area 214, the positive determination is made. When the orientation is rotated around the second axis 226d relative to the initial orientation, because the viewing area 12 deviates from the movable area 214 in the y-direction, the negative determination is made. When the positive determination is made in Step S237, the process proceeds to Step S240. When the negative determination is made in Step S237, the process proceeds to Step S242.

When it is determined that the position PE of the eye 7 falls within the movable area 214 in the y-direction and the z-direction, and when the viewing area 12 falls within the movable area 214 in the y-direction, the ideal orientation of the concave mirror 226 is calculated in Step S240 by the rotational driving around the first axis 26c. Specifically, the ideal orientation of the concave mirror 226 is calculated to be associated with the position PE of the eye 7 calculated in Step S220, assuming that the rotational driving around the second axis 226d is stopped to maintain the initial orientation. A rotational driving amount of the first axis 26c to put the concave mirror 226 into the ideal orientation is calculated on the basis of a relative position of the eye 7 calculated in Step S220 to the present viewing area 12. After processing in Step S240, the process proceeds to Step S250.

In Step S250, the orientation of the concave mirror 226 is adjusted by the rotational driving around the first axis 26c. The stepping motor 26b that has received the drive signal rotationally drives the concave mirror 226 around the first axis 26c to change the orientation of the concave mirror 226 on the basis of the rotational driving amount of the first axis 26c calculated in Step S240. With Step S250, a series of processing is completed.

When it is determined that the position PE of the eye 7 falls within the movable area 214 in the y-direction and the z-direction, and when the viewing area 12 deviates from the movable area 214 in the y-direction, the ideal orientation of the concave mirror 226 obtained by the rotational driving around the first axis 26c and the rotational driving around the second axis 226d is calculated in Step S242. Specifically, the ideal orientation of the concave mirror 226 is calculated to be associated with the position PE of the eye 7 calculated in Step S220, assuming that the orientation of the concave mirror 226 is the initial orientation. The respective rotational driving amounts of the first axis 26c and the second axis 226d to put the concave mirror 226 into the ideal orientation are calculated on the basis of a relative position of the eye 7 calculated in Step S220 to the present viewing area 12. After processing in Step S242, the process proceeds to Step S252.

In Step S252, the orientation of the concave mirror 226 is adjusted by the rotational driving around the first axis 26c and the rotational driving around the second axis 226d. The stepping motors 26b and 226e that have received the respective drive signals rotationally drive the concave mirror 226 around the first axis 26c and the second axis 226d to change the orientation of the concave mirror 226 on the basis of the rotational driving amounts of the first axis 26c and the second axis 226d calculated in Step S240. In other words, the viewing area 12 moves into the movable area 214 in Step S252. With Step S252, a series of processing is completed.

When it is determined that the position PE of the occupant's eye 7 deviates from the movable area 214 in the y-direction in Step S236, the ideal orientation of the concave mirror 226 by the rotational driving around the first axis 26c and the rotational driving around the second axis 226d is calculated in Step S244. Specifically, assuming that both of the rotational driving around the first axis 26c and the rotational driving around the second axis 226d are performed, the ideal orientation of the concave mirror 226 is calculated to be associated with the position PE of the eye 7 calculated in Step S220. The respective rotational driving amounts of the first axis 26c and the second axis 226d to put the concave mirror 226 into the ideal orientation are calculated on the basis of a relative position of the eye 7 calculated in Step S220 to the present viewing area 12. After processing in Step S244, the process proceeds to Step S254.

In Step S254, the orientation of the concave mirror 226 is adjusted by the rotational driving around the first axis 26c and the rotational driving around the second axis 226d. The stepping motors 26b and 226e that have received the respective drive signals rotationally drive the concave mirror 226 around the first axis 26c and the second axis 226d to change the orientation of the concave mirror 226 on the basis of the rotational driving amounts of the first axis 26c and the second axis 226d calculated in Step S240. In other words, Step S254 causes the viewing area 12 to deviate from the movable area 214 in the y-direction. With Step S254, a series of processing is completed.

The same idea as that in the first embodiment is applied to the rotational driving of the first axis 26c for the ideal orientation in the second embodiment. As to the rotational driving of the second axis 226d, the orientation by the minimum rotational driving around the second axis 226d for allowing the position PE of the eye 7 calculated in Step S220 to fall within the viewing area 12 is set as the ideal orientation on the basis of the initial orientation.

Similarly, in the second embodiment, the control circuit 30 automatically adjusts the orientation of the concave mirror 226 so as to match the orientation associated with the relative position on the basis of the relative position of the occupant's eye 7 imaged by the in-vehicle camera 6a to the viewing area 12. Therefore, similarly, in the second embodiment, the same effects as those in the above first embodiment can be obtained.

According to the second embodiment, in the virtual image 10 displayed with the width in the lateral direction that is the y-direction, a difference may occur in the distortion between the right and left sides with respect to the center of the virtual image 10 due to the rotational driving around the second axis 226d of the concave mirror 226. Under the circumstances, when it is determined that the position PE of the imaged occupant's eye 7 falls within the movable area 214 in the y-direction and the z-direction, and the viewing area 12 falls within the movable area 214 in the y-direction, the rotational driving around the second axis 226d is stopped, and the orientation of the concave mirror 226 is automatically adjusted by the rotational driving around the first axis 26c. According to the above configuration, the difference is restrained from occurring in the distortion between the right and left sides of the virtual image 10, and the orientation of the concave mirror 226 can be automatically adjusted.

According to the second embodiment, when it is determined that the position PE of the eye 7 falls within the movable area 214 in the y-direction and the z-direction, and when the viewing area 12 deviates from the movable area 214 in the y-direction, the orientation of the concave mirror 226 is automatically adjusted by the rotational driving around the first axis 26c and the rotational driving around the second axis 226d. According to the above configuration, the difference is restrained from occurring in the distortion between the right and left sides of the virtual image 10, and the orientation of the concave mirror 226 can be automatically adjusted.

According to the second embodiment, when it is determined that the position PE of the imaged occupant's eye 7 deviates from the movable area 214 in the y-direction, the orientation of the concave mirror 226 is automatically adjusted by the rotational driving around the first axis 26c and the rotational driving around the second axis 226d. According to the above configuration, the virtual image 10 can be visually displayed for the occupant with the eye deviating from the viewing area 12 in the y-direction.

According to the second embodiment, the operation for automatically adjusting the orientation of the concave mirror 226 starts when the parking state of the vehicle 1 is canceled. According to the above configuration, since the orientation of the concave mirror 226 can be automatically adjusted in a state where the occupant is in a driving position, the HUD device 200 can automatically adjust the orientation of the concave mirror 226 to the display position matching the position PE of the eye 7 of the occupant who is driving.

Meanwhile, in the second embodiment, the in-vehicle camera 6a configures “imaging unit”, and the control circuit 30 that executes Steps S250, S252, and S254 configures “adjustment unit”. The control circuit 30 that executes Steps S230, S236, and S237 configures “determination unit”, and the control circuit 30 that executes Step S232 configures “alert unit”.

### Third Embodiment

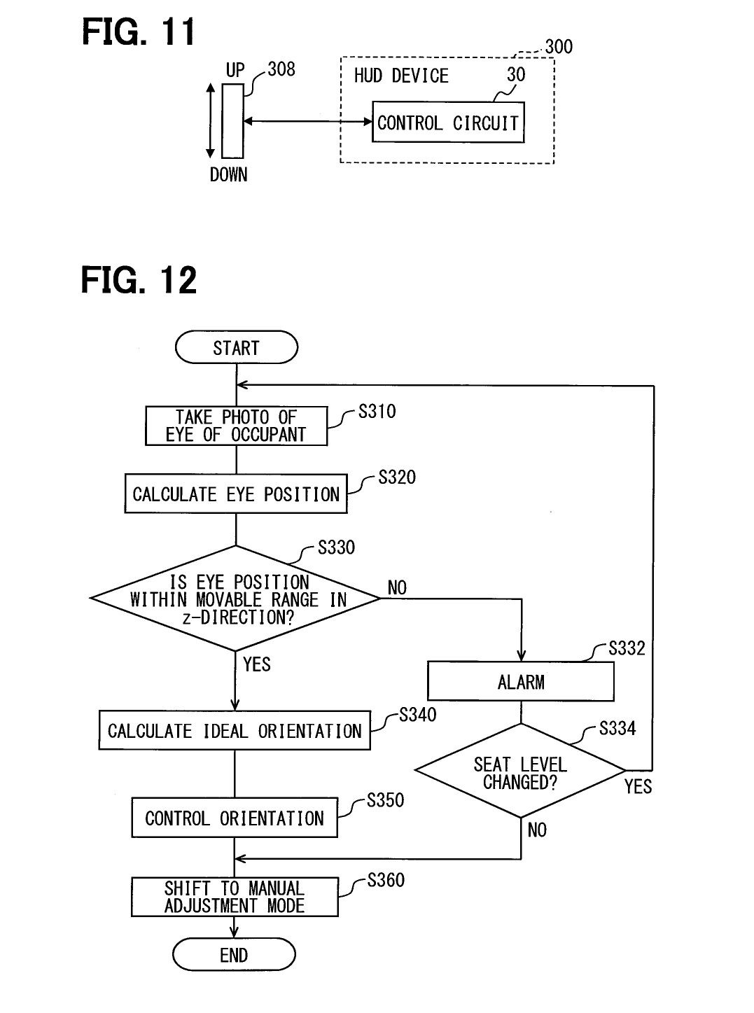

As illustrated in FIGS. 11 and 12, a third embodiment is a modification of the first embodiment. In the third embodiment, configurations different from those in the first embodiment will be mainly described.

A control circuit 30 according to the third embodiment is electrically connected to a manual adjustment switch 308 illustrated in FIG. 11 in addition to the block diagram of FIG. 6. The manual adjustment switch 308 is vertically tiltably formed. In a manual adjustment mode in which the control circuit 30 permits an input of the manual adjustment switch 308, when an upper side of the manual adjustment switch 308 is depressed, an orientation of a concave mirror 26 is rotationally driven around a first axis 26c, and a display position of a virtual image 10 is moved in a z-direction, upward relative to a vehicle 1. In addition, when a lower side of the manual adjustment switch 308 is depressed, the orientation of the concave mirror 26 is rotationally driven reversely to the above case, and the display position of the virtual image 10 is moved in the z-direction, downward relative to the vehicle 1. In addition, although not shown, the control circuit 30 is electrically connected to a luminance adjustment switch. In the manual adjustment mode, when the luminance adjustment switch is operated, the control circuit 30 can manually adjust an output of a light source of a projector, and adjust a luminance of a virtual image.

Next, a flowchart will be described with reference to FIG. 12, which is implemented by the execution of the computer program by the control circuit 30 in the first embodiment in cooperation with the monitoring system 6 when an engine switch of the vehicle 1 is turned on.

In Steps S310 to S330, the same control as that in Steps S10 to S30 in the first embodiment is conducted. When it is determined that a position PE of occupant's eye 7 falls within a movable area 14 in the z-direction in Step S330, the same control as that in Steps S40 to S50 of the first embodiment is performed In Steps S340 to S350. After processing in Step S350, in other words, after the orientation of the concave mirror 26 has been automatically adjusted, the process proceeds to Step S360.

In Step S360, the operation mode is shifted to the manual adjustment mode. In other words, the control circuit 30 permits the input of the manual adjustment switch 308 whereby the occupant can manually adjust the orientation of the concave mirror 26 through the manual adjustment switch 308. With Step 360, a series of processing is completed.

When it is determined that the position PE of occupant's eye 7 deviates from the movable area 14 in the z-direction in Step S330, the same control as that in Steps S32 to S34 of the first embodiment is performed in Steps S332 to S334. Meanwhile, when a negative determination is made in Step S334, the process proceeds to Step S360.

Similarly, in the third embodiment, the control circuit 30 automatically adjusts the orientation of the concave mirror 26 so as to match the orientation associated with the relative position on the basis of the relative position of the occupant's eye 7 imaged by the in-vehicle camera 6a to the viewing area 12. Therefore, similarly, in the third embodiment, the same effects as those in the above first embodiment can be obtained.

In addition, according to the third embodiment, after the orientation of the concave mirror 26 has been automatically adjusted, the occupant can manually adjust the orientation of the concave mirror 26. According to the above configuration, even if it is difficult for the occupant to perform the adjustment from a state where the virtual image 10 is not visually recognized, the occupant can perform manual adjustment such as fine adjustment to visibility matching an occupant's preference after the control circuit 30 of the HUD device 300 has automatically adjusted the orientation of the concave mirror 26 so that the virtual image 10 is viewable.

In the third embodiment, the in-vehicle camera 6a configures “imaging unit”, and the control circuit 30 that executes Step S350 configures “adjustment unit”. The control circuit 30 that executes Step S330 configures “determination unit”, and the control circuit 30 that executes Step S332 configures “alert unit”.

### Other Embodiments

The multiple embodiments have been described above, but the interpretation of the present disclosure is not limited to these embodiments and the disclosure can be applied to various embodiments and the combination of those embodiments without departing from the spirit of the present disclosure.

Specifically, in a modification 1 of the first to third embodiments, an optical member whose orientation is changeable may be formed of, for example, a plane mirror 24 other than the concave mirror 26.

In a modification 2 of the first to third embodiments, an ideal orientation may be calculated on the basis of another idea. For example, in the rotational driving of the first axis 26c, the ideal orientation may be an orientation of the concave mirror 26 by the minimum rotational driving around the first axis 26c in order that the position PE of the eye 7 calculated in Step S20, S220, S320 falls within the viewing area 12.

In a modification 3 of the first to third embodiments, the processing in Step S20, S30, S32, S34, S40, S220, S230, S232, S234, S236, S237, S240, S242, S320, S330, S332, S334, S340 may be performed by, for example, the meter 4 other than the control circuit 30.

In a modification 4 of the first to third embodiments, alert in Step S32, S232, S332 may be performed by displaying an alert message on a navigation screen of the vehicle 1, or performed by voice.

In a modification 5 of the first to third embodiments, when a height of a seat is changed after alerting in Step S32, S232, S332, imaging in Step S10, S210, S310 may again start when the occupant depresses an automatic adjustment button provided in the vehicle 1.

In a modification 6 of the first and third embodiments, the operation for automatically adjusting the orientation of a concave mirror 26, in other words, Step S10, S310 may start when a parking state is canceled, instead when turning on an engine switch.

In a modification 7 of the second embodiment, processing corresponding to Step S360 in which the orientation of a concave mirror 226 can be manually adjusted by an occupant may be added after automatically adjusting the orientation of the concave mirror 226.

In a modification 8 of the second embodiment, the operation for automatically adjusting the orientation of a concave mirror 226, that is, Step S210 may start when turning on an engine switch instead when cancelling a parking state.

In a modification 9 of the second embodiment, it may be determined that a parking state is canceled when at least one of a parking brake and a parking range in a shift lever is canceled.

In a modification 10 of the first to third embodiments, the operation for automatically adjusting the orientation of a concave mirror 26, in other words, Step S10, S210, S310 may start when an occupant depresses an automatic adjustment button provided in a vehicle 1 instead when turning on an engine switch, or cancelling a parking state.

In a modification 11 of the first to third embodiments, an HUD device 100 may be applied to various mobile objects (transport equipment) such as ships or airplanes other than vehicles.

What is claimed is:

1. A head-up display device that is mounted on a mobile object having an imaging unit which images an eye of an occupant, the head-up display device projecting an image on a projection member of the mobile object to display a virtual image visible by the occupant in a viewing area, the head-up display device comprising:
an optical system including an optical member to move the viewing area according to an orientation of the optical member which is changeable;
an adjustment unit that automatically adjusts the orientation of the optical member to be associated with a relative position of the eye imaged by the imaging unit relative to the viewing area; and
a determination unit that determines whether a position of the eye imaged by the imaging unit falls within a movable area of the viewing area movable in a z-direction by the optical system, the z-direction being defined by a vertical direction of the mobile object, wherein
the optical member has a first axis,
the optical system moves the viewing area in the z-direction by changing the orientation of the optical member by rotational driving around the first axis, and
the adjustment unit automatically adjusts the orientation of the optical member by the rotational driving around the first axis when the determination unit determines that the position of the eye falls within the movable area in the z-direction.

2. (canceled)

3. The head-up display device according to claim 1, further comprising:
an alert unit that alerts the occupant to change a height of a seat on which the occupant is seated when the determination unit determines that the position of the eye imaged by the imaging unit deviates from the movable area in the z-direction.

4. The head-up display device according to claim 3, wherein
the adjustment unit starts to automatically adjust the orientation of the optical member when the height of the seat is changed.

5. The head-up display device according to claim 1, wherein
the virtual image is projected frontward in the mobile object, and a lateral direction of the mobile object is defined as a y-direction,
the virtual image having a width in the y-direction is displayed in front of the mobile object,
the optical member has a second axis,
the optical system moves the viewing area in the y-direction by changing the orientation of the optical member by rotational driving around the second axis, and
the adjustment unit stops the rotational driving around the second axis and automatically adjusts the orientation of the optical member by the rotational driving around the first axis, when the determination unit determines that the position of the eye falls within the movable area in the y-direction and the z-direction, and when the viewing area falls within the movable area in the y-direction.

6. The head-up display device according to claim 5, wherein
the adjustment unit automatically adjusts the orientation of the optical member by the rotational driving around the first axis and the rotational driving around the second axis, when the determination unit determines that the position of the eye falls within the movable area in the y-direction and the z-direction, and that the viewing area deviates from the movable area in the y-direction.

7. The head-up display device according to claim 5, wherein
the adjustment unit automatically adjusts the orientation of the optical member by the rotational driving around the first axis and the rotational driving around the second axis when the determination unit determines that the position of the eye deviates from the movable area in the y-direction.

8. The head-up display device according to claim 1, wherein
the adjustment unit starts to automatically adjust the orientation of the optical member at a time when a parking state of the mobile object is canceled.

9. The head-up display device according to claim 1, wherein
the orientation of the optical member is manually adjustable by the occupant after the adjustment unit automatically adjusts the orientation of the optical member.
